(19) United States
(12) Patent Application Publication
(10) Pub. No.: US 2012/0016708 A1
(43) Pub. Date: Jan. 19, 2012

(54) DYNAMIC MANAGEMENT OF INVITATIONS TO A MEETING UTILIZING A CASCADED TIER OF POTENTIAL INVITEES

(75) Inventors: VIJAY DHEAP, DURHAM, NC (US); ABHINAY R. NAGPAL, PUNE (IN); SANDEEP R. PATIL, PUNE (IN); YAN W. STEIN, SAN JOSE, CA (US)

(73) Assignee: INTERNATIONAL BUSINESS MACHINES CORPORATION, ARMONK, NY (US)

(21) Appl. No.: 12/836,019

(22) Filed: Jul. 14, 2010

(51) Int. Cl. G06Q 10/00

(52) U.S. Cl. 705/7.19

(57) ABSTRACT

A computer implemented method dynamically manages invitations to a meeting. A first tier of potential invitees to a meeting and a second tier of potential invitees to the meeting are defined. Members of the second tier of potential invitees have been predetermined to have a lower need to attend the meeting than members of the first tier of potential invitees. Invitations for the meeting are first transmitted to members of the first tier of potential invitees. Invitation acceptance responses are received, and if they fail to reach a predetermined level such that resources for the meeting will be underutilized, additional invitations for the meeting are transmitted to members of the second tier of potential invitees.

### BACKGROUND

The present disclosure relates to the field of computers, and specifically to the use of computers to disseminate information. Still more particularly, the present disclosure relates to the use of computers to disseminate information related to meetings.

Meetings are a staple of enterprise operations. Such meetings may be teleconferences (e.g., a web conferences, video conferences, phone calls, etc.) or face-to-face meetings in conference rooms, auditoriums, etc. An organizer of a meeting can propose a topic, time, date and location for the meeting in invitations that are sent to potential attendees. These potential attendees then accept, decline or ignore the invitations.

### BRIEF SUMMARY

In one embodiment of the present disclosure, a computer implemented method dynamically manages invitations to a meeting. A first tier of potential invitees to a meeting and a second tier of potential invitees to the meeting are defined. Members of the second tier of potential invitees have been predetermined to have a lower need to attend the meeting than members of the first tier of potential invitees. Invitations for the meeting are first transmitted to members of the first tier of potential invitees. Invitation acceptance responses are received, and if they fail to reach a predetermined level such that resources for the meeting will be underutilized, additional invitations for the meeting are transmitted to members of the second tier of potential invitees.

In one embodiment of the present disclosure, a computer system comprises: a central processing unit; and a memory coupled to the central processing unit, wherein the memory comprises software that, when executed, causes the central processing unit to implement: defining a first tier of potential invitees to a future meeting and a second tier of potential invitees to the future meeting, wherein members of the second tier of potential invitees have been predetermined to have a lower need to attend the future meeting than members of the first tier of potential invitees; transmitting a plurality of invitations for the future meeting to members of the first tier of potential invitees; receiving invitation acceptance responses to the plurality of invitations from members of the first tier of potential invitees; determining if received invitation acceptance responses fail to reach a predetermined level, wherein failing to reach the predetermined level will result in resources for the future meeting being underutilized; and in response to the received invitation acceptance responses failing to reach the predetermined level, transmitting an additional invitation for the future meeting to a member of the second tier of potential invitees.

In one embodiment of the present disclosure, a computer program product comprises: a computer readable storage medium having computer readable program code embodied therewith, the computer readable program code comprising: computer readable program code to define a first tier of potential invitees to a future meeting and a second tier of potential invitees to the future meeting, wherein members of the second tier of potential invitees have been predetermined to have a lower need to attend the future meeting than members of the first tier of potential invitees; computer readable program code to transmit a plurality of invitations for the future meeting to members of the first tier of potential invitees; computer readable program code to receive invitation acceptance responses to the plurality of invitations from members of the first tier of potential invitees; computer readable program code to determine if received invitation acceptance responses fail to reach a predetermined level, wherein failing to reach the predetermined level will result in resources for the future meeting being underutilized; and computer readable program code to, in response to the received invitation acceptance responses failing to reach the predetermined level, transmit an additional invitation for the future meeting to a member of the second tier of potential invitees.

### BRIEF DESCRIPTION OF THE SEVERAL VIEWS OF THE DRAWINGS

FIG. 1 depicts an exemplary computer in which the present disclosure may be implemented;

FIG. 2 illustrates an exemplary networked system in which a meeting moderator's computer dynamically controls which parties are invited to a meeting and/or provided with information from the meeting;

FIG. 3 depicts a tier system for classifying potential invitees to the meeting; and

FIG. 4 is a high level flow chart of one or more exemplary steps taken by a computer to dynamically control which parties are invited to a meeting through the use of a cascading tier system.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

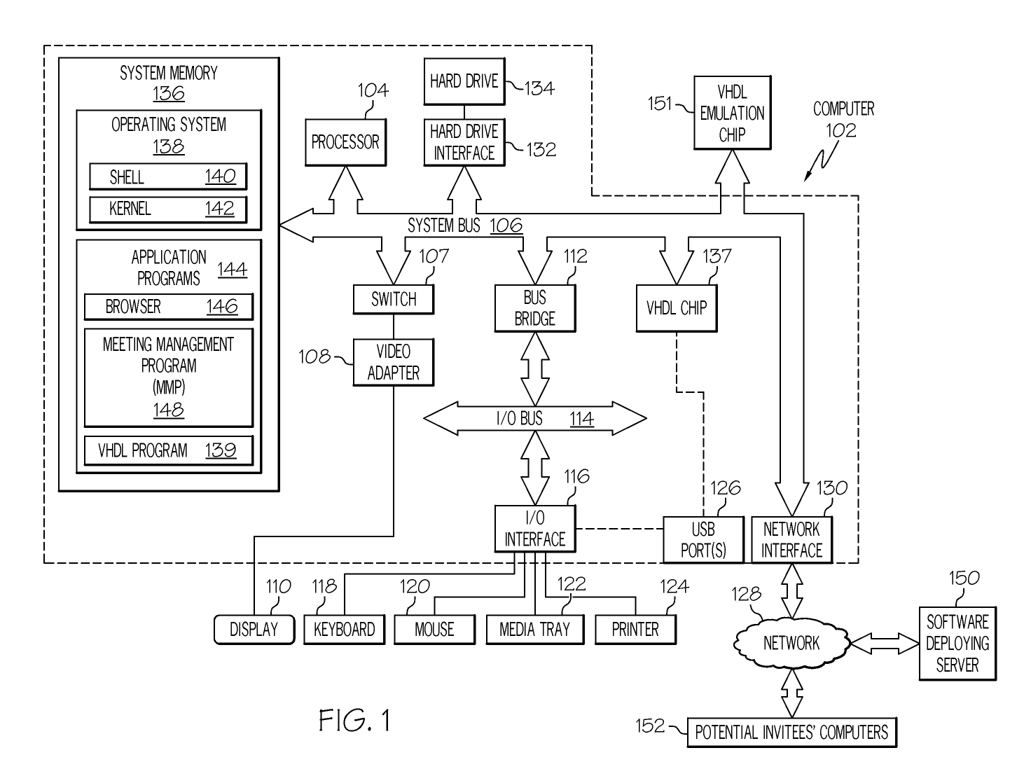

With reference now to the figures, and in particular to FIG. 1, there is depicted a block diagram of an exemplary computer 102, which may be utilized by the present disclosure. Note that some or all of the exemplary architecture, including both depicted hardware and software, shown for and within computer 102 may be utilized by software deploying server 150, and/or potential invitees' computers 152.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, which may be mechanical, that allows the display 110 to be coupled to the system bus 106, and thus to be functional only upon execution of instructions (e.g., meeting management program—MMP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 and/or potential invitees' computers 152 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present disclosure will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

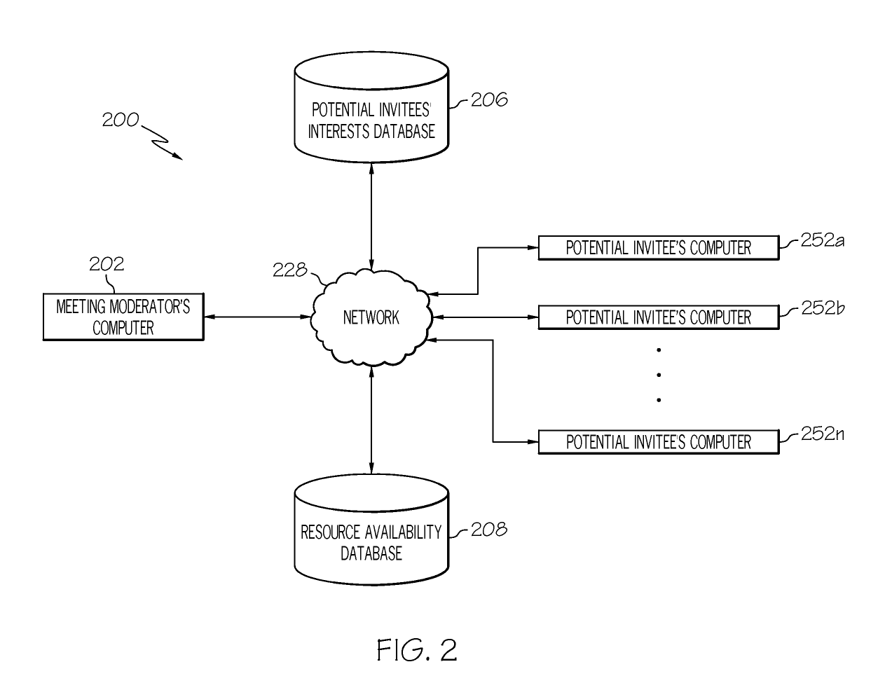

Application programs 144 in computer 102's system memory (as well as software deploying server 150's system memory) also include a meeting management program (MMP) 148. MMP 148 includes code for implementing the processes described below, including those described in FIGS. 2-4. In one embodiment, computer 102 is able to download MMP 148 from software deploying server 150, including in an on-demand basis, such that the code from MMP 148 is not downloaded until runtime or otherwise immediately needed by computer 102. Note further that, in one embodiment of the present disclosure, software deploying server 150 performs all of the functions associated with the present disclosure (including execution of MMP 148), thus freeing computer 102 from having to use its own internal computing resources to execute MMP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from MMP 148 causes VHDL program 139 to configure VHDL chip 137, which may be an FPGA, ASIC, etc.

In another embodiment of the present disclosure, execution of instructions from MMP 148 results in a utilization of VHDL program 139 to program a VHDL emulation chip 151. VHDL emulation chip 151 may incorporate a similar architecture as described above for VHDL chip 137. Once MMP 148 and VHDL program 139 program VHDL emulation chip 151, VHDL emulation chip 151 performs, as hardware, some or all functions described by one or more executions of some or all of the instructions found in MMP 148. That is, the VHDL emulation chip 151 is a hardware emulation of some or all of the software instructions found in MMP 148. In one embodiment, VHDL emulation chip 151 is a programmable read only memory (PROM) that, once burned in accordance with instructions from MMP 148 and VHDL program 139, is permanently transformed into a new circuitry that performs the functions needed to perform the process described below in FIGS. 2-4.

The hardware elements depicted in computer 102 are not intended to be exhaustive, but rather are representative to highlight essential components required by the present disclosure. For instance, computer 102 may include alternate memory storage devices such as magnetic cassettes, digital versatile disks (DVDs), Bernoulli cartridges, and the like. These and other variations are intended to be within the spirit and scope of the present disclosure.

With reference now to FIG. 2, an exemplary networked system 200 in which a meeting moderator's computer 202 dynamically controls which parties are invited to a meeting and/or provided with information from the meeting is presented. A meeting moderator's computer 202 (analogous to computer 102 shown in FIG. 1) communicates via a network 228 with multiple potential invitee's computers 252a-n (where “n” is an integer). Potential invitee's computers 252a-n are analogous to potential invitees' computers 152 shown in FIG. 1. Also coupled to network 228, and thus meeting moderator's computer 202, are a potential invitees' interests database 206 and a resource availability database 208. Note that while MMP 148 used to control meetings and invitees may reside in meeting moderator's computer 202, in other embodiments logic for controlling such meetings and invitations to these meetings (e.g., MMP 148) may be a web-based application that is deployed on a web server and/or using a service oriented architecture (SOA). When MMP 148 is deployed from a web server, then the moderator and/or invitees to meetings go through a browser to perform the functions described herein.

The potential invitees' interests database 206 holds information that describes the interests, and thus the interest level for attending a meeting, of potential invitees to a meeting. For example, assume that a meeting that is being put on by a moderator (who uses the meeting moderator's computer 202) is about “Main Topic A”. A specific potential invitee (e.g., the user of potential invitee's computer 252a) may have a history of sending and/or receiving e-mails related to Main Topic A. Similarly, a specific potential invitee may have a profile (e.g., on a social network, an enterprise posting, etc.) showing that he is interested in and/or has experience in and/or is working on projects related to Main Topic A. These and similar indicators of the potential invitee's interests are stored in the potential invitees' interests database 206 to place potential invitees in different tiers, as described in further detail herein.

The resource availability database 208 dynamically describes what resources are currently available for a future meeting that the meeting moderator is planning. These resources may be a room in which to hold the meeting, printed material to be distributed during the meeting, transportation to and from the meeting, places on a web registry, etc. Similarly, phone lines and/or conference calls may be limited to a certain number of lines. As described herein, if additional resources become available (i.e., if a larger room opens up), then invitations to the meeting can be extended to potential invitees who were previously in a lower tier.

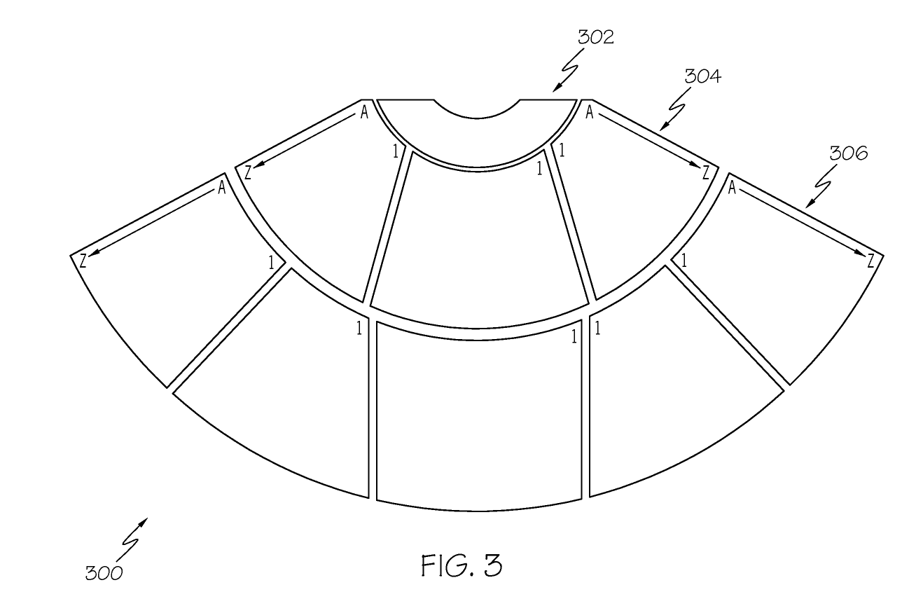

With reference now to FIG. 3, tier system 300 for classifying potential invitees to the meeting is presented. Depicted are three tiers, Tier 1 (302), Tier 2 (304), and Tier 3 (306). In one embodiment, fewer or more tiers can be defined. The exemplary three tiers 302-306 respectively represent a first tier 302 of potential invitees to a meeting, a second tier 304 of potential invitees to the meeting, and a third tier 306 of potential invitees to the meeting. In accordance with known interests of a specific person, and/or that person's need to attend the meeting (due to project demands, etc.), the specific person is assigned to one of the three tiers. This assignment can be automatically performed using logic within the meeting moderator's computer 202 (e.g., by executing MMP 148 shown in FIG. 1 in conjunction with a database describing attributes of various persons). Note that in at least one embodiment, potential invitees can move up or down in the tier system 300, as described in detail herein. Note also that each lower tier can be progressively larger, as depicted, or the tiers can be progressively smaller, the same size, or any variation of relative sizes. In any embodiment, a higher tier rating is indicative of a person's or group's preferential status to attend the future meeting. For example, members of first tier 302 are persons who should be given the first opportunity to attend the future meeting, based on their interests, needs, job descriptions, business relationship (e.g., highly valued customers) with the moderator, etc. Similarly, members of first tier 302 may be members who have actively participated in one or more past meetings that were about the same topic as that planned for the future meeting, thus indicating their strong interest in the topic of the future meeting. Members of the second tier 304 and the third tier 306 are given lesser preferences, based on the same or different criteria that placed others in the first tier 302.

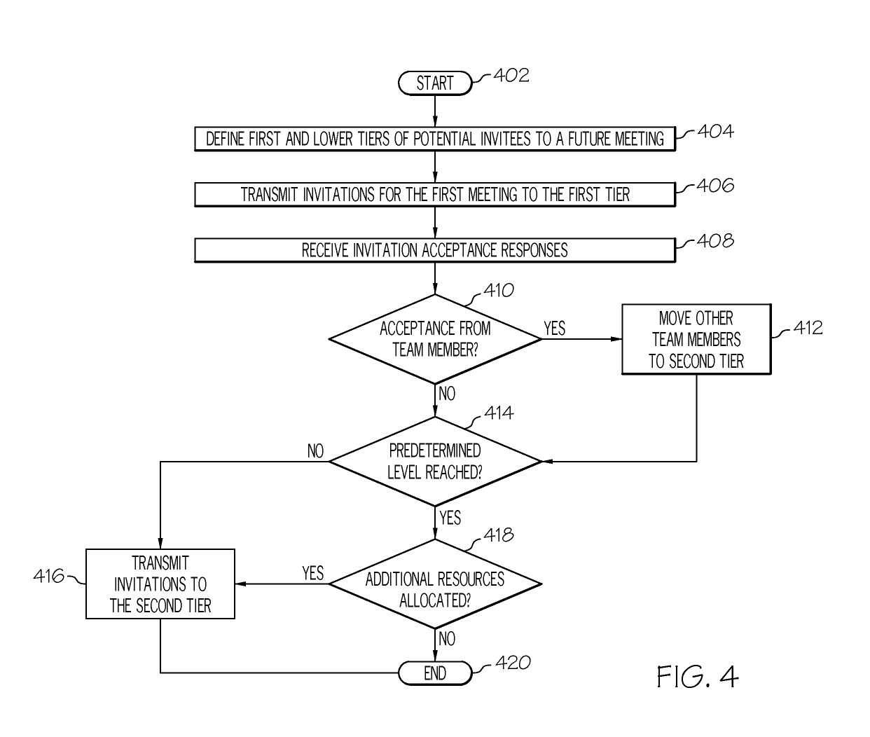

With reference now to FIG. 4, a high level flow chart of one or more exemplary steps taken by a computer to dynamically manage invitations to a future meeting through the use of a cascading tier system is presented. After initiator block 402, a first tier of potential invitees to a future meeting and lower tiers (e.g., a second tier, third tier, etc.) of potential invitees to the future meeting are defined (block 404). Members of the second tier of potential invitees have been predetermined to have a lower need to attend the future meeting than members of the first tier of potential invitees. For example, if a person had attended a past meeting that was devoted to the same topic as the planned future meeting, that person may be placed in the first tier of potential invitees, thus affording them the opportunity to continue to explore and develop that topic (e.g., to continue to work on an existing project). In another embodiment, persons who had not attended a past meeting that was devoted to the same topic may be placed in the first tier, thus affording them the opportunity to learn about that topic (e.g., to learn about a new company product).

As described in block 406, a plurality of invitations for the future meeting are then transmitted to members of the first tier of potential invitees. As described in block 408, invitation acceptance responses to the plurality of invitations are then received from members of the first tier of potential invitees. These invitation acceptance responses are responses indicating that the invitee will be attending the planned future meeting. In one embodiment, a determination can be made as to whether a member of a specific team has accepted the invitation (query block 410). Assume that this team member, as well as the rest of his team, has been previously assigned to Tier 1. A predefined rule may state that if one member of the team has accepted the invitation to the future meeting, then there is not as critical a need for other members of that team to attend. Therefore, these other team members are moved to a lower tier (e.g., the second tier of potential invitees), as described in block 412. These other team members will have their invitations automatically withdrawn. If addition space opens up, as described herein, then they may receive another invitation to the meeting.

As described in query block 414, a determination is made as to whether the received invitation acceptance responses fail to reach a predetermined level. Failing to reach the predetermined level will result in resources for the future meeting being underutilized. That is, if the meeting does not “fill up” (i.e., the received invitation acceptance responses fail to reach the predetermined level), then there will be vacant seats in the room, extra copies of handouts, etc. This predetermined level may need to be reached within a predefined period of time from when the initial set of invitations went out to the first tier members. If the predetermined level is not reached, either just before the meeting begins or within the shorter predefined period of time, then invitations can be extended to lower tier members (block 416) in order to utilize all available resources allocated to the future meeting. A set of subsequent invitations are thus sent to the second tier members. If the meeting still does not fill up, then additional invitations will be sent to third tier members, and so on.

Returning to query block 414, the meeting may initially fill up with members of the first tier of potential attendees to the future meeting, thus taking up all of the resources (space in the room, copies of handouts, etc.) for that meeting. However, a larger room may open up, and/or additional handouts can be printed (query block 418), thus enabling the moderator to invite members from the lower tiers to attend the meeting (block 416). These addition invitations can be automatically generated when the additional resources are allocated by executing software such as MMP 148 shown in FIG. 1. For example, assume that the meeting was originally scheduled to be held in a room that can hold 30 people. In this example, assume further that there are 30 persons in the first tier, and that they all accepted the invitation to the meeting. Subsequently a larger room capable of holding 50 people opens up. Now an additional 20 invitations can be extended to members of the second tier, thus utilizing all of the available resources (e.g., seats in the larger room).

The process ends at terminator block 420.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the disclosure of the present application in detail and by reference to illustrative embodiments thereof, it will be apparent that modifications and variations are possible without departing from the scope of the disclosure defined in the appended claims.

What is claimed is:

1. A computer implemented method to dynamically manage invitations to a future meeting, the computer implemented method comprising:
defining a first tier of potential invitees to a future meeting and a second tier of potential invitees to the future meeting, wherein members of the second tier of potential invitees have been predetermined to have a lower need to attend the future meeting than members of the first tier of potential invitees;
a processor transmitting a plurality of invitations for the future meeting to members of the first tier of potential invitees;
receiving invitation acceptance responses to the plurality of invitations from members of the first tier of potential invitees;
determining if received invitation acceptance responses fail to reach a predetermined level, wherein failing to reach the predetermined level will result in resources for the future meeting being underutilized; and
in response to the received invitation acceptance responses failing to reach the predetermined level, transmitting an additional invitation for the future meeting to a member of the second tier of potential invitees.

2. The computer implemented method of claim 1, further comprising:
determining that the received invitation acceptance responses reach the predetermined level; and
automatically transmitting the additional invitation to the member of the second tier of potential invitees in response to determining that additional resources for the future meeting have been allocated.

3. The computer implemented method of claim 1, further comprising:
in response to receiving an invitation acceptance to the future meeting from a member of a predefined group that is within the first tier of potential attendees, automatically moving other members of the predefined group from the first tier of potential invitees to the second tier of potential invitees.

4. The computer implemented method of claim 1, further comprising:
predetermining that members of the first tier of potential invitees have a higher need to attend the future meeting than members of the second tier of potential invitees by comparing a main topic of the future meeting with subject matters of past electronic communications with members of the first and second tiers of potential invitees.

5. The computer implemented method of claim 5, wherein the past electronic communications are previous e-mails with members of the first and second tiers of potential invitees.

6. The computer implemented method of claim 1, further comprising:
predetermining that members of the first tier of potential invitees have a higher need to attend the future meeting than members of the second tier of potential invitees by comparing a main topic of the future meeting with member-stated interests from profiles of members of the first and second tiers of potential invitees.

7. The computer implemented method of claim 1, further comprising:
assigning membership in the first tier of potential invitees to participants of past meetings, wherein the past meetings were devoted to a same topic as the future meeting.

8. The computer implemented method of claim 1, further comprising:
assigning membership in the first tier of potential invitees to parties who were not participants of past meetings, wherein the past meetings were devoted to a same topic as the future meeting.

9. The computer implemented method of claim 1, wherein resources for the future meeting comprise printed materials.

10. The computer implemented method of claim 1, wherein resources for the future meeting comprise available transportation.

11. A computer system comprising:
a central processing unit; and
a memory coupled to the central processing unit, wherein the memory comprises software that, when executed, causes the central processing unit to implement:
defining a first tier of potential invitees to a future meeting and a second tier of potential invitees to the future meeting, wherein members of the second tier of potential invitees have been predetermined to have a lower need to attend the future meeting than members of the first tier of potential invitees;
transmitting a plurality of invitations for the future meeting to members of the first tier of potential invitees;
receiving invitation acceptance responses to the plurality of invitations from members of the first tier of potential invitees;
determining if received invitation acceptance responses fail to reach a predetermined level, wherein failing to reach the predetermined level will result in resources for the future meeting being underutilized; and
in response to the received invitation acceptance responses failing to reach the predetermined level, transmitting an additional invitation for the future meeting to a member of the second tier of potential invitees.

12. The computer system of claim 11, wherein the software, when executed, further causes the central processing unit to implement:
determining that the received invitation acceptance responses reach the predetermined level; and
automatically transmitting the additional invitation to the member of the second tier of potential invitees in response to determining that additional resources for the future meeting have been allocated.

13. The computer system of claim 11, wherein the software, when executed, further causes the central processing unit to implement:
in response to receiving an invitation acceptance to the future meeting from a member of a predefined group that is within the first tier of potential attendees, automatically moving other members of the predefined group from the first tier of potential invitees to the second tier of potential invitees.

14. The computer system of claim 11, wherein the software, when executed, further causes the central processing unit to implement:
predetermining that members of the first tier of potential invitees have a higher need to attend the future meeting than members of the second tier of potential invitees by comparing a main topic of the future meeting with subject matters of past electronic communications with members of the first and second tiers of potential invitees.

15. The computer system of claim 11, wherein the software, when executed, further causes the central processing unit to implement:
predetermining that members of the first tier of potential invitees have a higher need to attend the future meeting than members of the second tier of potential invitees by comparing a main topic of the future meeting with member-stated interests from profiles of members of the first and second tiers of potential invitees.

16. A computer program product comprising:
a computer readable storage medium having computer readable program code embodied therewith, the computer readable program code comprising:
computer readable program code to define a first tier of potential invitees to a future meeting and a second tier of potential invitees to the future meeting, wherein members of the second tier of potential invitees have been predetermined to have a lower need to attend the future meeting than members of the first tier of potential invitees;
computer readable program code to transmit a plurality of invitations for the future meeting to members of the first tier of potential invitees;
computer readable program code to receive invitation acceptance responses to the plurality of invitations from members of the first tier of potential invitees;
computer readable program code to determine if received invitation acceptance responses fail to reach a predetermined level, wherein failing to reach the predetermined level will result in resources for the future meeting being underutilized; and
computer readable program code to, in response to the received invitation acceptance responses failing to reach the predetermined level, transmit an additional invitation for the future meeting to a member of the second tier of potential invitees.

17. The computer program product of claim 16, wherein the computer readable program code further comprises:
computer readable program code to determine that the received invitation acceptance responses reach the predetermined level; and
computer readable program code to automatically transmit the additional invitation to the member of the second tier of potential invitees in response to determining that additional resources for the future meeting have been allocated.

18. The computer program product of claim 16, wherein the computer readable program code further comprises:
computer readable program code to, in response to receiving an invitation acceptance to the future meeting from a member of a predefined group that is within the first tier of potential attendees, automatically move other members of the predefined group from the first tier of potential invitees to the second tier of potential invitees.

19. The computer program product of claim 16, wherein the computer readable program code further comprises:
computer readable program code to predetermine that members of the first tier of potential invitees have a higher need to attend the future meeting than members of the second tier of potential invitees by comparing a main topic of the future meeting with subject matters of past electronic communications with members of the first and second tiers of potential invitees.

20. The computer program product of claim 16, wherein the computer readable program code further comprises:
computer readable program code to predetermine that members of the first tier of potential invitees have a higher need to attend the future meeting than members of the second tier of potential invitees by comparing a main topic of the future meeting with member-stated interests from profiles of members of the first and second tiers of potential invitees.
